(19) United States
(12) Patent Application Publication
(10) Pub. No.: US 2011/0189437 A1
(43) Pub. Date: Aug. 4, 2011

(54) METHOD OF MAKING A THERMOPLASTIC FILM WITH A THREE-DIMENSIONALLY STRUCTURED SURFACE

(76) Inventors: Gruendken Marcel, Gronau (DE); Herbert Bader, Nordwalde (DE); Andreas Hagemann, Rhede (DE)

(21) Appl. No.: 12/764,176

(22) Filed: Apr. 21, 2010

(30) Foreign Application Priority Data
Apr. 22, 2009 (EP) 09005613.6

(51) Int. Cl. B32B 3/00; B29C 55/18

(52) U.S. Cl. 428/156; 264/173.15

(57) ABSTRACT

A thermoplastic film with a three-dimensionally structured outer surface is made by coextruding through a slit nozzle a multilayer molten plastic film having an outer layer formed of a thermoplastic polyurethane elastomer with an isocyanate additive and an inner layer. This multilayer film is compressed in a nip between a roll and a belt to emboss a three-dimensional structure into the outer layer. The roll is cooled to cool the film and set the three-dimensional structure in the outer surface of the outer layer.

### FIELD OF THE INVENTION

The invention relates to a method of making a thermoplastic film with a three-dimensionally structured surface. This invention further relates to a novel thermoplastic film with a three-dimensionally structured surface.

### BACKGROUND OF THE INVENTION

Thermoplastic polymers are plastics that remain thermoplastic even when they are repeatedly heated and cooled in the temperature range typical for the material for processing and use. Thermoplastic means the property of a plastic to repeatedly soften when heated and harden when cooled in a temperature range determined by the type of plastic. When soft, thermoplastic materials can be shaped to form objects by plastic flow over a die, or can be extruded or deep drawn.

The surfaces of plastic molded parts are often provided with a structuring for optical and tactile reasons. Particularly in the field of automobile interiors, a strong trend can be observed toward improving the quality impression. This trend has meant that structured surfaces are used to an increased extent. A leather look can be simulated, for example, by structured surfaces. A use of structured surfaces is also advantageous for improving the feel or scratch resistance.

To produce molded parts with a structured surface, for example, the grain structure and component geometry are made in a 24686 tool mold as a negative matrix, the mold skin is shaped by sintering or spraying processes and subsequently removed. After a subsequent back-foaming process, a three-dimensional component is obtained, the grain structure of which corresponds to the grain inserted into the mold

WO 2007/104588 [US 2009/0001752] describes a method of making a thermoplastic film with a three-dimensionally structured, embossed surface. The film is subjected to an electron-beam cross-linking. Thereby individual extensive areas of the film are cross-linked to a different extent. Regions which are subjected to higher degrees of drawing in a shape-imparting process have degrees of cross-linking differing from neighboring regions.

WO 2006/122606 [US 2008/0136065] describes a method of making three-dimensionally structured surfaces of objects. The object thereby is the reproduction of an original surface. This way the topology of the original surface is determined and the data used to control a processing tool. In the document, the use of this method to produce embossing rollers for thermoplastic films is described. The reproduction surface is a roller surface. The three-dimensionally structured object surface is made as a negative of the original surface. Films are structured with these rollers. The method is used in particular with thermoplastic or elastic polymer films.

From WO 1999/022931 a method of making a multilayer optical film is known that has an outer layer with a structured surface of, for example polypropylene or polycarbonate. With this method, a multilayer plastic melt film is produced that is extruded into a nip between a cooled roll and a rotating belt and three-dimensionally embossed in this nip as well as cooled at the same time. The belt can be a metal belt.

In EP 1 316 402 [US 2003/0187170] a method is described for the production of nanostructured and microstructured polymer films. A melt film is inserted into a nip formed by a roll and a form tool wrapped around the roll. The form tool is provided with a relief that represents the negative of the surface structure to be produced on the polymer film.

EP 1 852 239 [US 2007/0257390] describes a method of making a three-dimensional free-form surface with haptically and optically detectable microstructures. The elongations caused in the forming process of the free-form surface are thereby determined. An elastic film is processed such that at least one is structure-supporting surface is produced on the film.

DE 10 2006 021 477 describes a method of forming microstructured three-dimensional free-form surfaces. First, a molded part is produced that has the microstructured surface taken from an original form. Then a core is prepared that has a shape that is milled to match that of the three-dimensional free-form surface. The molded part is then coated with a thin layer of polymer material and placed on the core. The layer of polymer material is then connected to the core. Subsequently the molded part is removed.

In the manufacture of molded parts with a structured surface, the grain structure can be applied by means of a film that already has a surface structure. With conventional methods, the surface structure is embossed onto the film, for example with a calender rolling mill. To produce molded parts, the film is then back-injected or back-pressed and thus deformed. In the forming process, the surface structure of the film is exposed to high pressure stresses and thermal stresses. This means that the structure changes or re-forms. This effect can be observed in particular in zones of marked deformation. Optically, this is also results in a shining of the film regions correspondingly formed. Also the memory effect of plastics is responsible for a recovery. This preferably occurs with increases in temperature.

In practice an attempt is made to trade off these effects. Corresponding regions can be structurally designed such that these effects are taken into consideration. Another possibility is to cross-link the corresponding regions. The molecular arrangement is thereby fixed.

### OBJECTS OF THE INVENTION

It is therefore an object of the present invention to provide an improved method of making a surface-structured thermoplastic film.

Another object is the provision of such an improved method of making a surface-structured thermoplastic film that overcomes the above-given disadvantages, in particular whose surface structure is retained during strong deformation.

A further object of the present invention is a novel thermoplastic film with a three-dimensionally structured surface prepared according to the method disclosed herein.

### SUMMARY OF THE INVENTION

A thermoplastic film with a three-dimensionally structured outer surface is made by coextruding through a slit nozzle a multilayer molten plastic film having an outer layer formed of a thermoplastic polyurethane elastomer with an isocyanate additive and an inner layer. This multilayer film is compressed in a nip between a roll and a belt to emboss a three-dimensional structure into the outer layer. The roll is cooled to cool the film and set the three-dimensional structure in the outer surface of the outer layer.

Methylene-di-p-phenylene isocyanate (MDI) or hexamethylene diisocyanate (HDI) have proven to be particularly suitable. It has proven to be particularly favorable to add them in a proportion of up to 20% by weight. More particularly, a content of methylene-di-p-phenylene isocyanate (MDI) or hexamethylene diisocyanate (HDI) of more than 6% by weight and less than 15% by weight in the layer of the film has proven to be particularly advantageous.

Isocyanates lead to a cross-linking of the polymers. The cross-linking of the polymers is produced by formation of bonds between the polymer chains. In conventional methods electron beam cross-linking is frequently used. In electron beam cross-linking the radicals starting the cross-linking process are produced by the action of energetic radiation on the polymer molecules. The radicals react in consecutive reactions with the molecules of the polymer chains and lead to the formation of covalent bonds between the individual chains as well as to the degradation of the macromolecules by chain cleavage. Chain cleavage and chain composition run parallel. According to the invention, cross-linking is achieved by incorporation of an isocyanate during the extrusion. This reactive extrusion causes an incipient cross-linking or an increase in molar mass. In addition to the increased grain stability, the stabilization of a matte structuring of the surface is also achieved, which likewise can be transferred by the surface of the sleeve belt or the cooled roll.

The layer under the outer layer can also be cross-linked is with an isocyanate. In addition, this layer can have a polymer with a high melt strength and/or elastomeric properties. For example, polyether block amide (PEBA), polyamide (PA), acrylonitrile butadiene styrene (ABS) or other styrene block copolymers are suitable as polymers.

The additional polymer is designed to provide a self-regulating effect during a deformation. The layers lying below it can be, for example, polyolefins, such as, for example polypropylene (PP), polyethylene (PE), thermoplastic olefin (TPO) or acrylonitrile butadiene styrene (ABS).

The metal belt or the circumferential area of the cooled roll has a three-dimensional grain structure that is transferred to the melt film. The metal belt is, for example, a rotating continuous steel belt. By use of this special steel so-called sleeve belt, optimal optical and mechanical properties are achieved in the produced films. As a result of the surface pressure, in contrast to the film produced with a normal calender, internal stresses and thus shrinkage are reduced for the further processing.

According to the invention, embossing is carried out at the same time as the film formation. It is achieved by a suitable process control such that grain initiation takes place in the thermoplastic range, i.e. in the molten state. Since the cooling rate is very high with the method according to the invention, the formation of crystallites is largely suppressed. An amorphous molecular structure is produced. According to the method of the invention, molded films are produced. With these films the grain structure as well as the actual film has a low relaxation potential. Since these films have amorphous structures, they are free of shrinkage and contraction.

With the method according to the invention, surface smoothing of the melt web on both sides, a contact cooling on both sides and a three-dimensional structuring of the film surface using the sleeve belt take place at the same time. Induced internal stresses in the film are reduced by pressing over a relatively large area. The film therefore shrinks less during further processing compared to a smoothed film.

In contrast to cast films, the films produced by this technology do not have nozzle lines due to the surface contact cooling on both sides. They have lower internal stresses compared to films smoothed in a conventional manner according to calender technology. The reason for this is the low contact pressures.

The tension of the sleeve belt is adjustable. The contact length of the sleeve belt with the film or the angle of wrap can also be changed according to product requirements.

With the method according to the invention the melt film is not cooled at a point on the roll as with the production of cast films or with sheet extrusion systems, but along the sleeve belt. A contact strip is thus formed between the melt film and the metal belt and can be, for example, 15 cm wide.

In particular structure films for use in the field of automobile interiors are produced with the method according to the invention. The structure films are back-injected or back pressed and can thereby be deformed in a three-dimensional manner in order, for example to form interior motor-vehicle trim parts. The films produced according to the method according to the invention are characterized by very advantageous properties. They can have up to five layers, and for example by using a rigid core layer, the grain stability can be improved. Different polymers can be combined, and it is also possible to use more cost-effective raw materials or recycled products in lower layers. The structure surface is very scratch-resistant due to the use of TPU and is characterized by good tactile properties. The outer structured layer that was formed by reactive extrusion with the addition of isocyanates has a high melt strength, which is very important for the described use of the film. In the production of interior motor-vehicle trim parts in which the film is back-injected or back-injected and thereby deformed in a three-dimensional manner, the surface structure is exposed to high pressures and high temperatures. The film according to the invention thus retains its surface structure and shows the desired structure and a permanent matting even in particularly critical deformation regions after the production of the molded article. An additional lacquer coating for surface protection is not necessary due to the advantageous properties of the structure surface according to the invention.

### BRIEF DESCRIPTION OF THE DRAWING

The above and other objects, features, and advantages will become more readily apparent from the following description, reference being made to the accompanying drawing in which:

FIG. 1A shows a molded part covered by an embossed film;

FIG. 1B is a large-scale section through a corner of the film shaped to conform to the part;

FIG. 2 shows a method of embossing thermoplastic films in the sleeve-touch process;

FIG. 3 is a graph illustrating the influence of the proportion of methylene-di-p-phenylene isocyanate (MDI) on the tensile strengths and the expansions of films; and

FIG. 4 is a large-scale section showing the layers of a film produced according to the reactive extrusion method.

### SPECIFIC DESCRIPTION

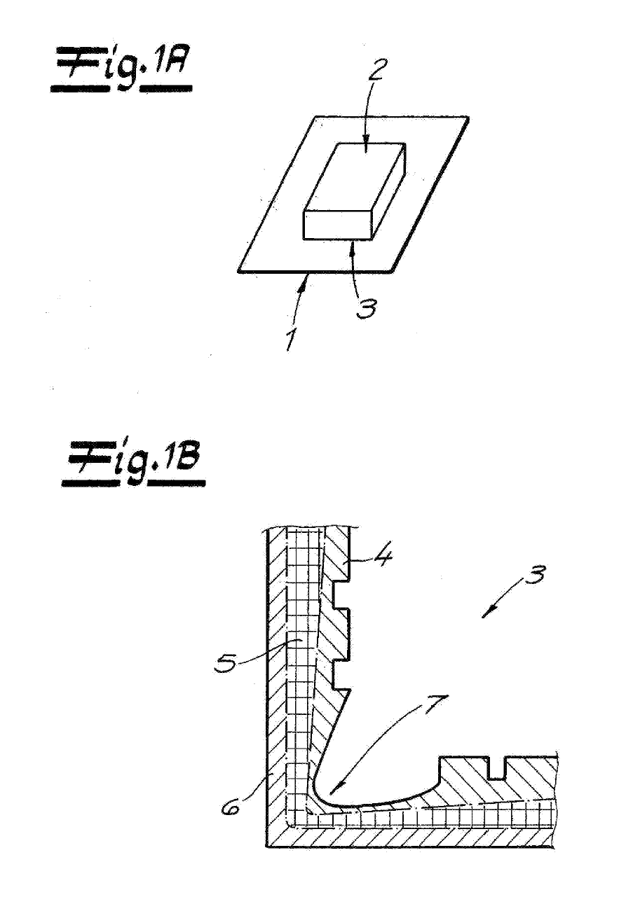

As seen in FIG. 1A, a thermoplastic film 1 is stretched over a die 2 and wraps around corners 3 of the die 2. This corner region is shown enlarged in FIG. 1B in cross section. The film 1 is composed of inner, intermediate and outer layers 4, 5 and 6. The outer layer 4 is embossed. The three-dimensionally structured surface of the film can be, for example, a grain or a leather look. The intermediate layer 5 is located between the inner layer 6 and the outer layer 4. The foil fits at 3 around the corner 3 of the die 2 at 7. At this point 7 the problem of flattening of the grain or surface structure is discernible. Optically this problem is also indicated by a shining of the film region correspondingly deformed.

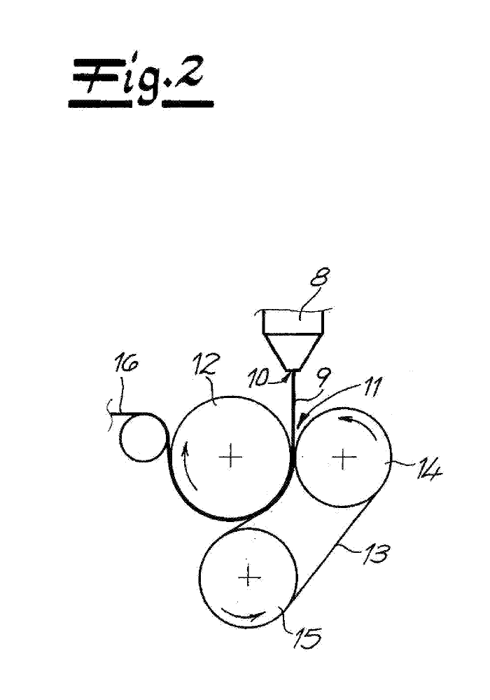

FIG. 2 shows the method according to the invention for is producing a three-dimensionally structured surface. An extruder 8 forces a melt film 9 through a flat sheeting or slot die or nozzle 10. The melt film 9 flows out of the die 10 into a nip 11 between a cooled roll 12 and a metal sleeve belt 13. The metal belt 13 is continuous, made of steel, and stretched between rollers 14 and 15. The tension in the metal belt 13 is adjustable. The contact length of the metal belt 13 with the melt film 9 can also be changed according to manufacturing requirements.

According to the invention, a three-dimensional shape is embossed on the melt film 9 in the nip 11 between the cooled roll 12 and the metal strip 13. To this end, the metal belt 13 has a three-dimensional surface grain structure that is transferred to the melt film 9. The face on the film side of the metal belt 13 forms the female mold of the three-dimensional surface structure to be applied. The melt film 9 is embossed by the metal belt 13 with the desired positive surface structure. Alternatively, instead of the metal belt the outer surface of the cooled roll 12 can have the three-dimensional grain structure that is transferred to the melt film 9.

The three-dimensional surface formation is produced in the film 9 in the thermoplastic range, i.e. while it is still soft and molten. The cooling rate of the melt film is very high with this process. Crystal formation is thus largely suppressed and an amorphous molecular structure is produced.

The embossed film 16 can be wound or deposited by a format separating and stacking unit.

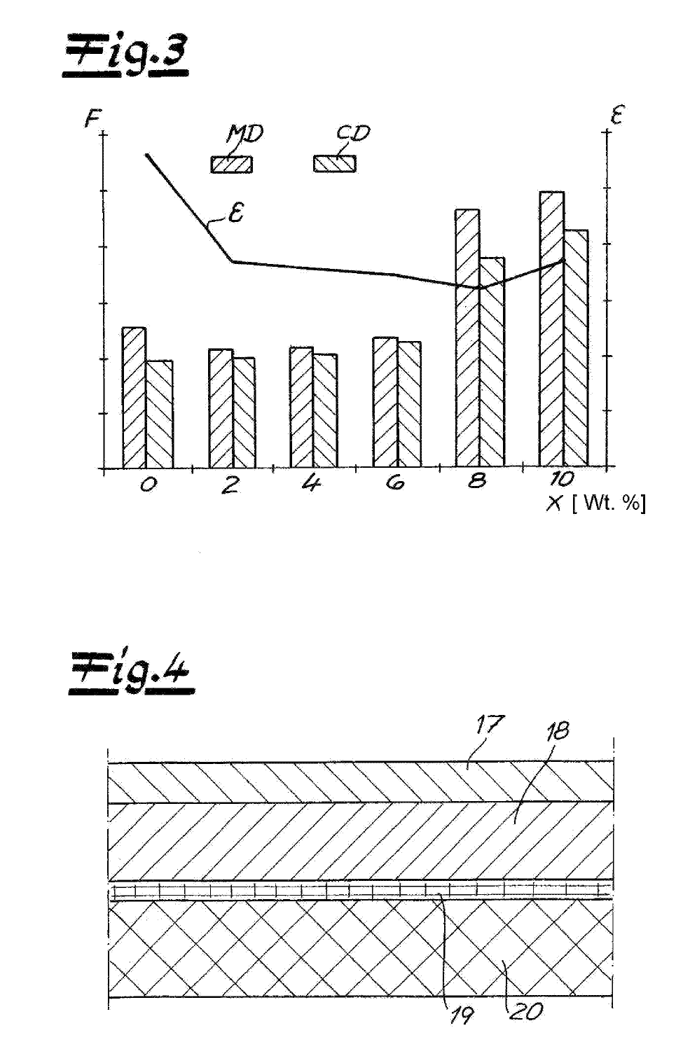

FIG. 3 shows the influence of the proportion X of methylene-di-p-phenylene isocyanate (MDI) on the tensile strengths F in the longitudinal machine direction MD as well as in the transverse direction CD and the elongations c. The tensile strengths are shown as bars in the diagram. With a content of MDI of 8 to 10% by weight, the tensile strength rises sharply.

The expansions are shown by a line. With an increasing proportion of MDI, the expansion decreases. It reaches its minimum with a proportion of 8% by weight MDI and rises slightly thereafter again.

FIG. 4 shows by way of example the structure of a multilayer film according to the invention. The outer layer 17 of the film that forms the outer surface of the molded part is composed of a thermoplastic polyurethane elastomer (TPU) to which 10% by weight isocyanate was added. The layer is 100 μm thick.

The intermediate layer 18 under the outer layer 17 was likewise cross-linked with an isocyanate. It contains 15% by weight isocyanate. The layer 18 is 200 μm thick. In addition, apart from a thermoplastic polyurethane elastomer (TPU), this layer contains a polyether block amide (PEBA). In principle, a polymer with a high melt strength and/or elastomeric properties should be used. The additional polymer causes a self-regulating effect during a deformation.

Below the layer 18 a bonding agent 19 with a thickness of 50 μm is applied. The lower layer 20 can be composed of polyolefins, such as, for example, polypropylene (PP) or thermoplastic polyurethane elastomers (TPU)

We claim:

1. A method of making a thermoplastic film with a three-dimensionally structured outer surface, the method comprising the steps of sequentially:
coextruding through a slit nozzle a multilayer molten plastic film having an outer layer formed of a thermoplastic polyurethane elastomer with an isocyanate additive and an inner layer;
compressing the multilayer film in a nip between a roll and a belt to emboss a three-dimensional structure into the outer to layer; and
cooling the roll to cool the film.

2. The method defined in claim 1 wherein the metal belt or the roll has an outer surface with a three-dimensional grain structure that is transferred to the film to form the three-dimensional structure thereon.

3. The method defined in claim 1, further comprising the step of
cooling the belt also to cool the film.

4. The method defined in claim 1 wherein the film is extruded with inner layer and with an intermediate layer formed by a mixture of a thermoplastic polyurethane elastomer, a polyester block amide, and an isocyanate between the outer layer and the inner layer.

5. The method defined in claim 4 wherein the intermediate and inner layers comprise methylene-di-p-phenylene isocyanate or hexamethylene diisocyanate of up to 20% by weight.

6. The method defined in claim 5 wherein the methylene-di-p-phenylene isocyanate or hexamethylene diisocyanate form more than 6% by weight and less than 12% by weight of the respective layer.

7. The thermoplastic film with a three-dimensionally structured outer surface prepared according to the method defined in claim 1.
